(19) United States
(12) Patent Application Publication
(10) Pub. No.: US 2026/0340337 A1
(43) Pub. Date: Oct. 29, 2026

(54) HyperOrg: Architectural Framework for Enabling Autonomous Organizational Intelligence (AOI)

(71) Applicants: Shrikarnag Bangalore Prahallada, Austin, TX (US); Ranjitha Sridhar Rao Nag, Austin, TX (US); Lohith Dayananda Ram, Austin, TX (US); Shrivatsa Bangalore Prahallada, Poway, CA (US); Deepashree Abhaya, Poway, CA (US); Rudri Jani, Ahmedabad (IN)

(72) Inventors: Shrikarnag Bangalore Prahallada, Austin, TX (US); Ranjitha Sridhar Rao Nag, Austin, TX (US); Lohith Dayananda Ram, Austin, TX (US); Shrivatsa Bangalore Prahallada, Poway, CA (US); Deepashree Abhaya, Poway, CA (US); Rudri Jani, Ahmedabad (IN)

(21) Appl. No.: 19/636,955

(22) Filed: Apr. 2, 2026

Related U.S. Application Data
(60) Provisional application No. 63/796,882, filed on Apr. 29, 2025.

(51) Int. Cl. G06N 3/006; G06N 5/02; G06N 5/043; G06Q 10/067

(52) U.S. Cl. CPC G06N 3/006; G06N 5/02; G06N 5/043; G06Q 10/0672

(57) ABSTRACT

An architectural framework for enabling Autonomous Organizational Intelligence (AOI). The framework comprises: a Knowledge Graph Layer that centralizes organizational data including goals, policies, workflows, and key performance indicators in a dynamic interconnected graph; a Multi-Agent AI Layer comprising specialized autonomous agents including planning, budgeting, strategy, and action agents that access the knowledge graph to make and coordinate organizational decisions; an Execution Layer that implements agent decisions through application programming interfaces connected to third-party enterprise platforms including project management, HR, and finance systems; and a Feedback and Learning Loop that captures execution outcomes, evaluates them against organizational goals, and updates both the knowledge graph and agent behavioral models. The framework enables organizations to self-manage core functions through AI-driven autonomy, shifting from human-dependent workflows to adaptive, continuously learning organizational systems.

### CROSS-REFERENCE TO RELATED APPLICATIONS

This application claims the benefit of U.S. Provisional Application No. [INSERT PROVISIONAL APPLICATION NUMBER], filed Apr. 29, 2025, the entire contents of which are hereby incorporated by reference.

### FIELD OF THE INVENTION

The present invention relates generally to the field of artificial intelligence and enterprise software systems. More specifically, the invention relates to an architectural framework that enables organizations to make decisions, execute actions, and adapt autonomously using an AI-driven multi-agent architecture designed to support Autonomous Organizational Intelligence (AOI).

### BACKGROUND OF THE INVENTION

Traditional organizations rely heavily on human-led decision-making, siloed communication, and static operational workflows. While digital transformation and automation tools have advanced organizational efficiency, they fall short of creating systems that can adapt, decide, and act without continuous human intervention.

Existing technologies such as business intelligence platforms, rule-based automation systems, and enterprise resource planning (ERP) tools are fragmented, reactive, and lack integrated self-governance capabilities. Prior art includes expert systems, robotic process automation (RPA), and early implementations of enterprise AI, which offer decision support but not autonomous execution across organizational domains.

These systems typically require predefined rules, human oversight, and manual coordination between components. No existing framework offers a unified, modular, and evolvable architecture that continuously learns, adapts, and autonomously operates across strategy, execution, and feedback cycles at the organizational level.

HyperOrg addresses these limitations by proposing an integrated architectural foundation for Autonomous Organizational Intelligence (AOI). It enables organizations to self-manage core functions—such as decision-making, resource allocation, and operational alignment—through a multi-agent AI framework and scalable infrastructure. It represents a paradigm shift from tools that support humans to systems that operate organizations with minimal human oversight.

### SUMMARY OF THE INVENTION

The present invention provides an architectural framework for enabling Autonomous Organizational Intelligence (AOI)—a new class of systems that allow organizations to self-manage, optimize, and act independently across operations. The framework shifts organizational management from human-dependent workflows to adaptive, AI-driven execution and decision-making.

In one embodiment, the framework comprises four main components: (1) a Knowledge Graph that centralizes data on goals, people, policies, and KPIs to provide context for decisions; (2) a Multi-Agent AI Layer comprising a network of specialized agents that make decisions and coordinate autonomously; (3) an Execution Layer that connects to third-party enterprise tools to perform tasks automatically; and (4) a Feedback and Learning Loop that continuously evaluates outcomes, updates agents and the knowledge graph, and supports organizational learning.

### DETAILED DESCRIPTION OF THE INVENTION

HyperOrg is an architectural framework for enabling Autonomous Organizational Intelligence (AOI)—a new class of systems that allow organizations to self-manage, optimize, and act independently across operations.

### Knowledge Graph Layer

The Knowledge Graph Layer organizes structured and unstructured data including goals, workflows, KPIs, policies, people data, and organizational context into a dynamic, interconnected graph. This layer centralizes organizational knowledge to provide real-time context for autonomous decision-making. The Knowledge Graph may integrate with vector databases, relational systems, or hybrid data architectures depending on deployment requirements.

### Multi-Agent AI Layer

The Multi-Agent AI Layer comprises a network of specialized AI agents including, but not limited to, a Planning Agent, a Budgeting Agent, a Strategy Agent, and an Action Agent. Each agent is configured to make autonomous decisions within its domain by accessing the Knowledge Graph. Agents communicate and coordinate with each other to resolve cross-functional dependencies. Different agent configurations can be deployed for different industries and organizational structures. The agents employ AI models including large language models, reinforcement learning, and rule-based engines, selected based on the decision domain and required autonomy level.

### Execution Layer

The Execution Layer implements agent decisions through application programming interfaces connected to third-party enterprise platforms including project management systems, HR platforms, finance systems, and communication tools. The Execution Layer supports multiple integration protocols including REST, GraphQL, and low-code connectors. This layer translates agent decisions into concrete organizational actions such as task assignments, budget allocations, schedule modifications, and communication dispatches.

### Feedback and Learning Loop

The Monitoring and Feedback Loop captures execution outcomes, compares them to organizational goals and KPIs, and updates both the Knowledge Graph and agent behavior models. This creates a continuous organizational learning cycle wherein the system improves its decision-making accuracy over time. The feedback loop operates across multiple time horizons: real-time for operational adjustments, weekly for tactical refinements, and quarterly for strategic recalibration.

### Process Flow

Data flows into the Knowledge Graph from enterprise platforms and sensors. The Multi-Agent AI Layer accesses the Knowledge Graph for context and makes autonomous decisions. The Execution Layer implements those decisions through connected enterprise tools. The Monitoring and Feedback Loop captures results, evaluates them against goals, and updates the Knowledge Graph and agent models. This creates a self-governing, continuously learning organizational system.

### Problem Solved

Unlike static and human-reliant systems, HyperOrg creates organizations that can learn, adapt, and act autonomously without continuous human management. Current enterprise systems rely on manual input, rigid rules, and fragmented tools. HyperOrg eliminates these bottlenecks through AI-powered autonomy, enabling faster, smarter, and more aligned operations.

### Possible Variations

HyperOrg can be deployed via cloud, on-premises, or hybrid models. Different agent sets can be configured for different industries. The Knowledge Graph can integrate with various database architectures. The framework is adaptable to any domain where complex, distributed operations benefit from AI-driven autonomy.

### Other Uses and Applications

While HyperOrg is primarily designed for enabling Autonomous Organizational Intelligence in businesses, it can also be applied to other fields. Potential uses include automating governance in smart cities, managing decentralized operations in research institutions, enabling autonomous nonprofit organizations, orchestrating complex logistics networks, and coordinating multi-agent systems in defense or emergency response sectors. Because HyperOrg is fundamentally about autonomous decision-making, execution, and learning, it can be adapted to any domain where complex, distributed operations benefit from AI-driven autonomy.

### BRIEF DESCRIPTION OF THE DRAWINGS

FIG. 1 illustrates the HyperOrg system architecture, showing the Knowledge Graph (containing Policies, Goals, People, KPIs) providing Context to the Multi-Agent AI layer (comprising Planner Agent, Budgeting Agent, Strategy Agent, and Action Agent), which connects to the Execution Layer (comprising Project Management, HR, and Finance modules) that interfaces with Third-Party Tools. Communication and Feedback channels connect all layers in a bidirectional flow.

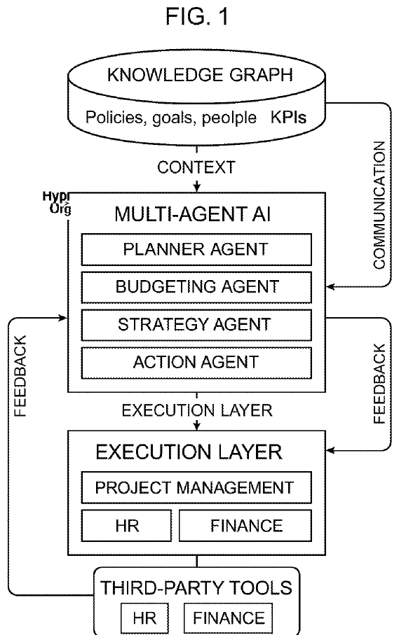

FIG. 2 illustrates the Feedback and Learning Loop, showing the cycle from Knowledge Graph (step 2) to Multi-Agent AI (step 3) to Execution (step 0) to Monitoring (step 4) and back to Knowledge Graph, creating a continuous self-improving system.

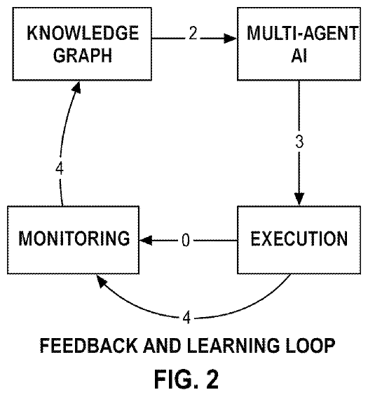

What is claimed is:

1. A system for autonomous organizational intelligence, comprising:
one or more processors; and
a non-transitory computer-readable memory storing instructions that, when executed by the one or more processors, cause the system to implement:
(a) a knowledge graph layer configured to centralize and dynamically maintain organizational data comprising goals, policies, workflows, personnel data, and key performance indicators in an interconnected graph structure;
(b) a multi-agent artificial intelligence layer comprising a plurality of specialized autonomous agents, each configured to access the knowledge graph and make decisions within a defined organizational domain, wherein the plurality of agents includes at least a planning agent, a budgeting agent, and a strategy agent that coordinate with each other to resolve cross-functional dependencies;
(c) an execution layer configured to implement decisions generated by the multi-agent AI layer through application programming interfaces connected to one or more third-party enterprise platforms; and
(d) a feedback and learning loop configured to capture execution outcomes, compare the outcomes to organizational goals and key performance indicators, and update both the knowledge graph and agent behavioral models based on the comparison.

2. The system of claim 1, wherein the multi-agent AI layer employs at least one of: large language models, reinforcement learning algorithms, and rule-based decision engines.

3. The system of claim 1, wherein the execution layer supports integration with third-party enterprise platforms through at least one of: REST application programming interfaces, GraphQL interfaces, and low-code connectors.

4. The system of claim 1, wherein the third-party enterprise platforms include at least two of: project management systems, human resources platforms, finance management systems, and communication platforms.

5. The system of claim 1, wherein the feedback and learning loop operates across multiple time horizons comprising real-time operational adjustments, periodic tactical refinements, and strategic recalibration.

6. The system of claim 1, wherein the plurality of specialized autonomous agents are configurable for different industry verticals including at least one of: technology, healthcare, manufacturing, defense, and logistics.

7. The system of claim 1, wherein the knowledge graph layer integrates with at least one of: vector databases, relational databases, and graph databases.

8. A computer-implemented method for enabling autonomous organizational management, comprising:
(a) constructing, by one or more processors, a knowledge graph that centralizes organizational data comprising goals, policies, workflows, personnel data, and key performance indicators;
(b) deploying a plurality of specialized AI agents, each assigned to a defined organizational domain, wherein each agent autonomously accesses the knowledge graph to make decisions within its domain and coordinates with other agents to resolve cross-functional dependencies;
(c) executing, through application programming interfaces connected to third-party enterprise platforms, the decisions generated by the plurality of AI agents;
(d) monitoring execution outcomes and comparing the outcomes to organizational goals and key performance indicators; and
(e) updating the knowledge graph and agent behavioral models based on the monitored outcomes, thereby creating a continuous organizational learning cycle.

9. The method of claim 8, wherein deploying the plurality of specialized AI agents comprises configuring at least one of: a planning agent for project timeline management, a budgeting agent for financial allocation, a strategy agent for organizational alignment, and an action agent for task execution.

10. The method of claim 8, wherein the step of executing decisions comprises translating agent decisions into at least one of: task assignments, budget allocations, schedule modifications, resource reallocations, and communication dispatches.

11. The method of claim 8, further comprising adjusting agent decision-making parameters based on feedback received from the monitoring step without requiring human intervention.

12. The method of claim 8, wherein the method is performed in at least one of: a cloud computing environment, an on-premises computing environment, and a hybrid computing environment.

13. A non-transitory computer-readable medium storing instructions that, when executed by one or more processors, cause the one or more processors to perform a method comprising:
maintaining a dynamic knowledge graph that represents organizational structure, goals, policies, and performance metrics;
instantiating a plurality of autonomous AI agents that access the knowledge graph to make organizational decisions across planning, budgeting, strategy, and execution domains;
coordinating the plurality of AI agents to resolve cross-functional dependencies through inter-agent communication protocols;
implementing agent decisions through integrations with third-party enterprise software systems; and
continuously refining agent decision models and the knowledge graph based on execution feedback.

14. The non-transitory computer-readable medium of claim 13, wherein the inter-agent communication protocols comprise at least one of: message passing, shared memory through the knowledge graph, and hierarchical decision escalation.

15. The non-transitory computer-readable medium of claim 13, wherein the autonomous AI agents operate with graduated levels of autonomy, wherein routine decisions are executed without human approval and strategic decisions are flagged for human review.
